(19) United States
(12) Patent Application Publication
(10) Pub. No.: US 2026/0099805 A1
(43) Pub. Date: Apr. 9, 2026

(54) INCREASING ACCURACY OF DELIVERY ADDRESSES

(71) Applicant: Walmart Apollo, LLC, Bentonville, AR (US)

(72) Inventors: Amit Bendale, Bangalore (IN); Anuja Sharan, Bangalore (IN); Rakshit Suri, Bangalore (IN)

(21) Appl. No.: 19/343,413

(22) Filed: Sep. 29, 2025

Related U.S. Application Data
(60) Provisional application No. 63/702,710, filed on Oct. 3, 2024.

(51) Int. Cl. G06Q 10/083

(52) U.S. Cl. CPC G06Q 10/0843; G06Q 10/0838

(57) ABSTRACT

Example implementations relate to improving an accuracy of an address. A set of address element inputs are received. A quality metric based on the set of address element inputs is computed using a first machine learning model. In accordance with a determination that the quality metric does not meet a threshold, an enriched address is generated based on the set of address element inputs. Feedback indicating an outcome of a delivery associated with the enriched address is received. The first machine learning model is re-train based on the feedback.

### CROSS REFERENCE TO RELATED APPLICATION

This application claims benefit to U.S. Provisional Patent Application No. 63/702,710, entitled “Accuracy of Delivery Addresses,” filed on Oct. 3, 2024, the disclosure of which is incorporated herein by reference in its entirety.

### TECHNICAL FIELD

This application relates generally to improving the accuracy of an address, and more particularly, to improving the quality of a delivery address provided by a user.

### BACKGROUND

A delivery address is a prerequisite for order fulfilment of physical items. Packages may be undeliverable due to address issues, which may cost businesses billions of dollars annually. The lack of an accurate delivery may impact businesses through order cancellations, delayed deliveries, failed deliveries, and/or returns, which may lead to lost revenue, extra fuel and human bandwidth costs, and/or customer dissatisfaction. Address issues may be due to human text-entry errors, location service (e.g., GPS) inaccuracies and inconsistencies. Existing solutions may only rely on governmental databases like the United States Postal Service (USPS) for address validation and their efficiency may decrease significantly in areas that lack such governmental databases.

### BRIEF DESCRIPTION OF THE DRAWINGS

Various examples will be described by the following detailed description, which is to be considered together with the accompanying drawings wherein like numbers refer to like parts and further wherein:

FIG. 1 illustrates a network environment that provides addresses having improved accuracy, in accordance with some embodiments;

FIG. 2 illustrates a computer system that implements one or more processes, in accordance with some embodiments;

FIG. 3 is a flowchart illustrating an address improvement method, in accordance with some embodiments;

FIG. 4 is a process flow illustrating various steps of an address improvement method performed in accordance with the block diagrams of FIGS. 5 and 6D, in accordance with some embodiments;

FIG. 5 is a block diagram illustrating various portions of an example address improvement system, in accordance with some embodiments;

FIG. 6A shows an example algorithm for enriching an address input provided by a user, in accordance with some embodiments;

FIG. 6B shows an example system that incorporates a component for enriching an address input provided by a user, in accordance with some embodiments;

FIG. 6C shows another example system that incorporates a component for enriching an address input provided by a user, in accordance with some embodiments;

FIG. 6D shows an example method for selecting a delivery address, in accordance with some embodiments;

FIG. 7 illustrates an example domain architecture for providing enriched addresses, in accordance with some embodiments;

FIG. 8 illustrates a tree-based ensemble machine learning model, in accordance with some embodiments;

FIG. 9 is a flowchart illustrating a training method for generating a trained machine learning model, in accordance with some embodiments; and

FIG. 10 is a process flow illustrating various steps of the training method of FIG. 9, in accordance with some embodiments.

### DETAILED DESCRIPTION

This description of the example embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

In various embodiments, a system including a non-transitory memory and a processor communicatively coupled to the non-transitory memory is disclosed. The processor reads a set of instructions to receive a set of address element inputs via a first interface, compute a quality metric based on the set of address element inputs using a first machine learning model, in accordance with a determination that the quality metric does not meet a threshold, generate an enriched address based on the set of address element inputs, receive feedback indicating an outcome of a delivery associated with the enriched address; and re-train the first machine learning model based on the feedback.

In various embodiments, a computer-implemented method is disclosed. The computer-implemented method includes steps of receiving a set of address element inputs via a first interface; computing a quality metric based on the set of address element inputs using a first machine learning model; in accordance with a determination that the quality metric does not meet a threshold, generating an enriched address based on the set of address element inputs; receiving feedback indicating an outcome of a delivery associated with the enriched address; and re-training the first machine learning model based on the feedback.

In various embodiments, a non-transitory computer readable medium having instructions stored thereon is disclosed. The instructions, when executed by at least one processor, cause at least one device to perform operations including receiving a set of address element inputs via a first interface; computing a quality metric based on the set of address element inputs using a first machine learning model; in accordance with a determination that the quality metric does not meet a threshold, generating an enriched address based on the set of address element inputs; receiving feedback indicating an outcome of a delivery associated with the enriched address; and re-training the first machine learning model based on the feedback.

Furthermore, in the following, various embodiments are described with respect to methods and systems for improving delivery addresses. In various embodiments, an address improvement system identifies problematic addresses by predicting a likelihood of an unsuccessful delivery based on a user entered address. The address improvement system may subsequently generate enriched addresses that may include address choices that lead to successful deliveries.

In some embodiments, systems, and methods for improving delivery addresses includes one or more trained delivery failure propensity models. The trained delivery failure propensity models may include one or more models, such as a classification model, to identify problematic addresses by predicting a likelihood of an unsuccessful delivery based on a user entered address.

In particular, by training based on training data, the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (also referred to as “feature learning”) may be used. In particular, the parameters of the trained functions may be adapted iteratively by several steps of training.

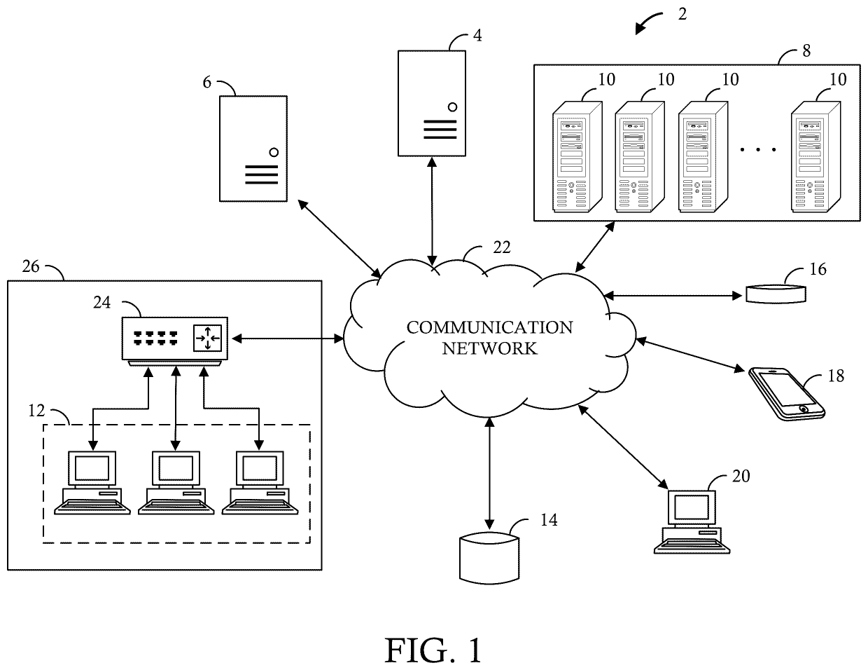

FIG. 1 illustrates a network environment 2 that provides improved/enriched delivery addresses, in accordance with some embodiments. The network environment 2 includes a plurality of devices or systems that communicate over one or more network channels, illustrated as a network cloud 22. For example, in various embodiments, the network environment 2 may include, but is not limited to, an address improvement computing device 4, a web server 6, a cloud-based engine 8 including one or more processing devices 10, a database 14, and/or one or more user computing devices 16, 18, 20 operatively coupled over the network 22. The address improvement computing device 4, the web server 6, the processing device(s) 10, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the address improvement computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the address improvement computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment. In some embodiments, the address improvement computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the address improvement computing device 4, for example. The workstation(s) 12 may communicate with the address improvement computing device 4 over the communication network 22. The workstation(s) 12 may send data to, and receive data from, the address improvement computing device 4. For example, the workstation(s) 12 may transmit data related to tracked operations performed at the physical location 26 to address improvement computing device 4.

Although FIG. 1 illustrates three user computing devices 16, 18, 20, the network environment 2 may include any number of user computing devices 16, 18, 20. Similarly, the network environment 2 may include any number of the address improvement computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the address improvement computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the user computing devices 16, 18, 20 may communicate with the web server 6 over the communication network 22. For example, each of the user computing devices 16, 18, 20 may be operable to view, access, and interact with a website, such as an e-commerce website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser, perform various operations such as searching one or more databases or catalogs associated with the displayed website, view item data for elements associated with and displayed on the website, and click on interface elements presented via the website, for example, in the search results. The website may capture these activities as user session data, and transmit the user session data to the address improvement computing device 4 over the communication network 22.

In some embodiments, and as will be described further herein below, the address improvement computing device 4 may execute one or more models, processes, or algorithms, such as a machine learning model, deep learning model, statistical model, etc., (e.g., as implemented as machine readable instructions) to detect problematic addresses and improve those addresses. The address improvement computing device 4 is further operable to communicate with the database 14 over the communication network 22. For example, the address improvement computing device 4 may store data to, and read data from, the database 14. The database 14 may be a remote storage device, such as a cloud-based server, a disk (e.g., a hard disk), a memory device on another application server, a networked computer, or any other suitable remote storage.

The address improvement computing device 4 is further operable to communicate with the database 14 over the communication network 22. For example, the address improvement computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the address improvement computing device 4, in some embodiments, the database 14 may be a local storage device, such as a hard drive, a non-volatile memory, or a USB stick. The address improvement computing device 4 may store interaction data received from the web server 6 in the database 14. The address improvement computing device 4 may also receive from the web server 6 user session data identifying events associated with browsing sessions, and may store the user session data in the database 14.

In some embodiments, the address improvement computing device 4 may implement machine readable instructions to receive a set of address element inputs via a first interface. For example, the address improvement computing device 4 may then receive, from the web server 6, user provided address input and/or other geolocation information (e.g., user input address 404). In some embodiments, the address improvement computing device 4 may implement machine readable instructions to compute a quality metric based on the set of address element inputs using a first machine learning mode. The address improvement computing device 4 may implement the models to identify problematic addresses by predicting a likelihood of an unsuccessful delivery based on a user entered address. For example, the address improvement computing device 4 may obtain one or more models from the database 14 to predict a likelihood of an unsuccessful delivery based on a user entered address. In some embodiments, the address improvement computing device 4 may implement machine readable instructions to generate an enriched address based on the set of address element inputs, in accordance with a determination that the quality metric does not meet a threshold. In some embodiments, the address improvement computing device 4 may implement machine readable instructions to receive feedback indicating an outcome of a delivery associated with the enriched address; and re-train the first machine learning model based on the feedback.

In some embodiments, the address improvement computing device 4 may assign the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, address improvement computing device 4 may generate enriched addresses that may include address choices that lead to successful deliveries.

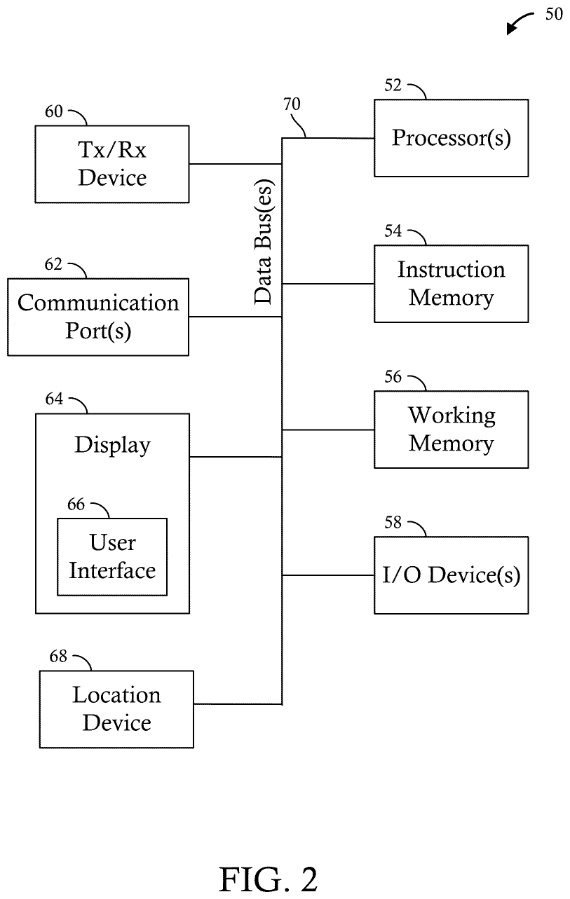

FIG. 2 illustrates a block diagram of a computing device 50, in accordance with some embodiments. In some embodiments, each of the address improvement computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 implements an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may perform a certain function or operation by executing code, stored on the instruction memory 54, embodying the function or operation. For example, the one or more processors 52 may execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit that operates as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for improving the accuracy of user entered addresses, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 allows communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 couples the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 utilize one or more communication protocols. Examples of wired protocols may include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device that receives position data identifying a latitude and longitude from one or more satellites of a GPS constellation. As another example, in some embodiments, the location device 68 is a cellular device that receives location data from one or more localized cellular towers. Based on the position data, the computing device 50 may determine a local geographical area (e.g., town, city, state, etc.) of its position.

In some embodiments, the computing device 50 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

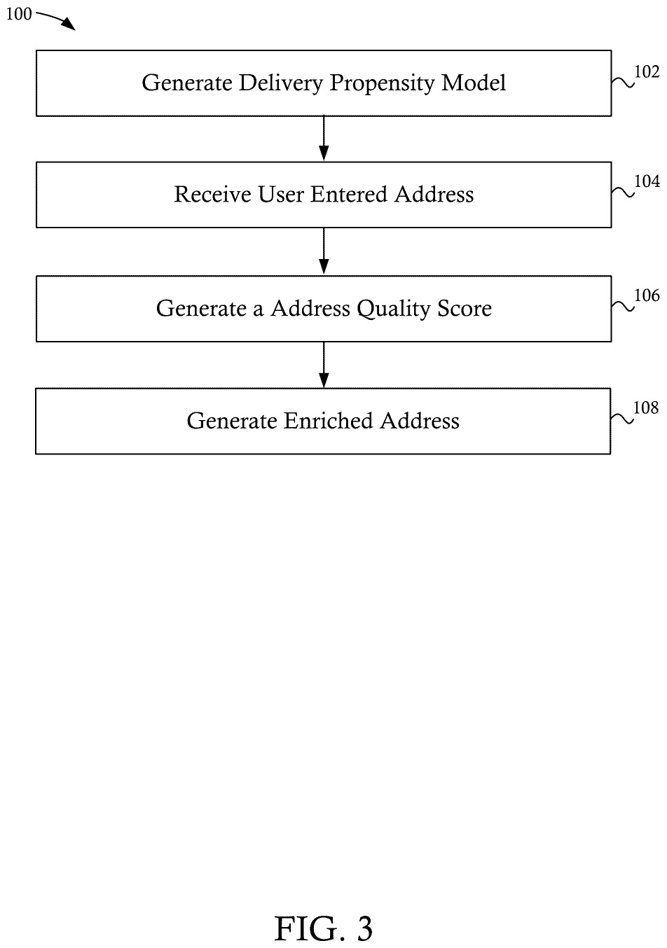

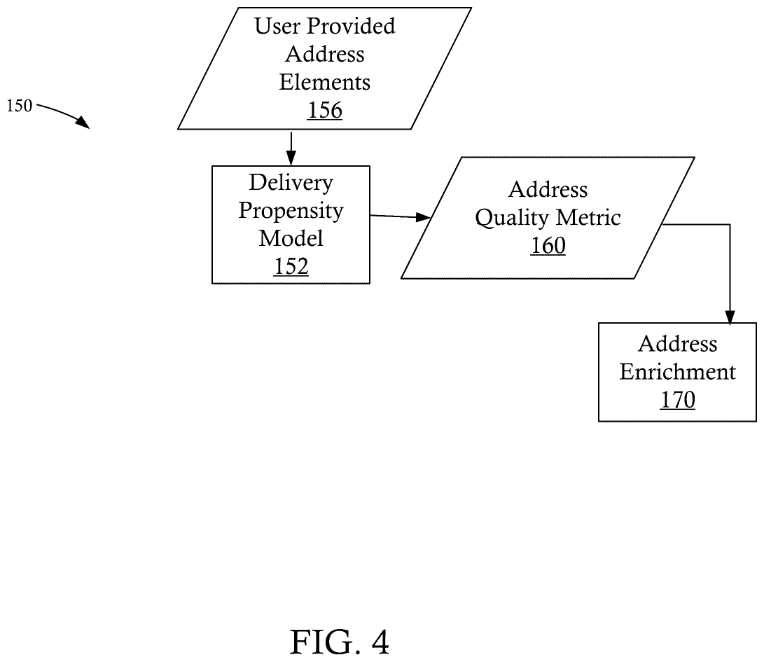

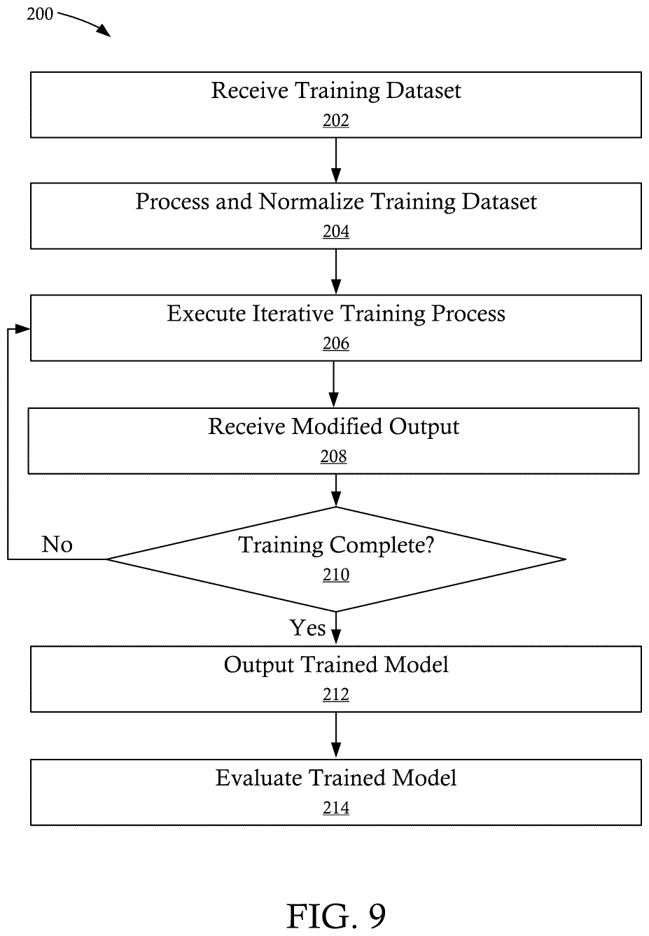

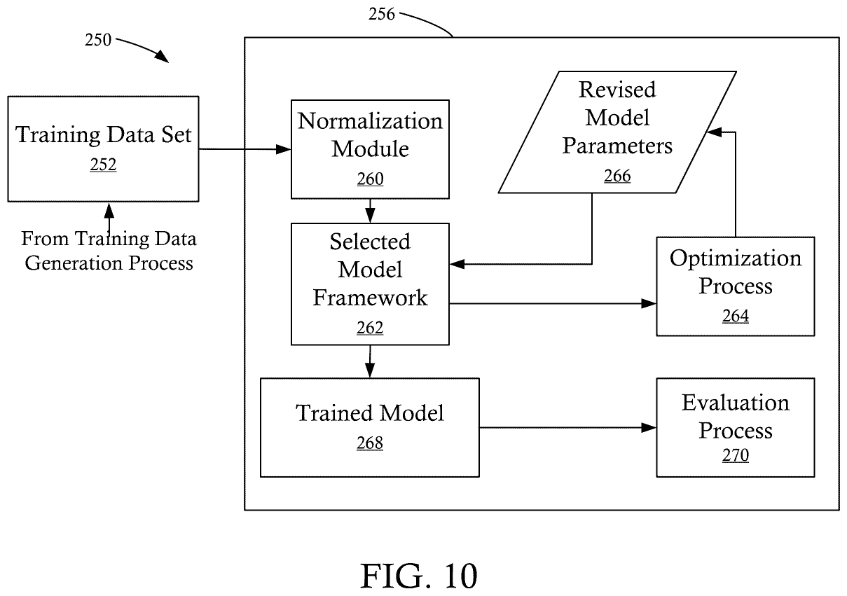

FIG. 3 is a flowchart illustrating an address enrichment method 100, in accordance with some embodiments. FIG. 4 is a process flow 150 illustrating various steps of the address enrichment method 100, in accordance with some embodiments. The address enrichment method 100 may be implemented by any suitable system, such as, for example, the address improvement computing device 4 discussed above. At step 102, a delivery propensity model 152 is generated. In some embodiments, the delivery propensity model 152 includes a trained machine learning model generated via an iterative training process, such as, for example, the iterative training process discussed below with respect to FIGS. 9-10. The delivery propensity model 152 generates a probability (e.g., a quality score, output score, prediction score, etc.) representative of a likelihood a delivery can be successfully made to an address (or alternatively, the likelihood that a delivery to a respective address will fail).

At step 104, an address entered by a user is received. User provided address elements 156 from step 104 are provided to the delivery propensity model 152. At step 106, an address quality metric 160 is computed for the user provided address elements 156. In accordance with a determination that the quality of the address does not meet a threshold (e.g., the quality metric 160 is lower than a predefined threshold), at step 108, address enrichment 170 is generated based on the received user provided address elements 156.

In some embodiments, a user interface element is displayed (e.g., a textbox) that allows a user to enter an address. In some embodiments, after a postal code is entered, one or more address fields (e.g., state, city, and/or country) are auto-filled (e.g., auto-populated) based on the postal code (e.g., a dropdown list of colonies based on the postal code, and/or auto-populated content may be based on a backend dataset). In some embodiments, textual address entered by the user is automatically converted into a location (e.g., indicated by a graphical user interface element, such as a location pin) on a map. In some embodiments, additionally or alternatively, a GPS component on a mobile device of the user (e.g., the location device 68) automatically provides a location of the user (e.g., automatically determined latitude and longitude coordinates of the user when the user interface element is displayed, sometimes referred to as “autoloc”), and the user is provided with a graphical user interface element (e.g., a location pin on a graphical map) that allows the user to adjust a particular location (e.g., pindrop, and/or move the graphical user interface element to adjust a respective location of the graphical user interface element) to obtain latitude and longitude coordinates that are based on the user adjusted location. In some embodiments, the address is a combination of the text address entered by the user and the latitude and longitude coordinates associated with the user pindrop. Delivery personnel may use the latitude and longitude coordinates (e.g., of the pindrop) to navigate to the delivery address. In some embodiments, the textual address provided by the user serves as a reference, and an enriched address generated in the manner described below is provided to the user during a checkout process (e.g., for purchasing an item from an ecommerce platform) and/or while the user is saving a user profile associated with the user, optionally while editing the user profile.

Textual address elements in an address may differ based on the country. For example, the textual text address elements in Mexico may include an interior number (e.g., a flat number, an apartment number etc.), an exterior number (e.g., a building number), street name, colony, municipality, postal code, city, and/or country.

The methods and systems described herein flag address issues in real-time even for addresses that have no prior/past usage, unlike applications that utilize simple auto-corrections. In the U.S., user provided addresses which are not verified by United States Postal Service (USPS) are not allowed to be saved, and such an approach allows for address correction. In some embodiments, the quality of an address is learned and validated from empirical signals of delivery failures, allowing the methods and systems described herein to be integrated with and/or plugged into any address validation system to predict the quality of address and recommend an address of a better quality, optionally in a platform-independent manner (e.g., decoupled from the platform). In some embodiments, addresses of customers to which delivery have been made successfully are provided to the recommendation system to circumvent issues associated with GPS-based address validation and verification systems lacking precision in a densely populated environment (e.g., optionally without any structured address) or a sparsely populated environment.

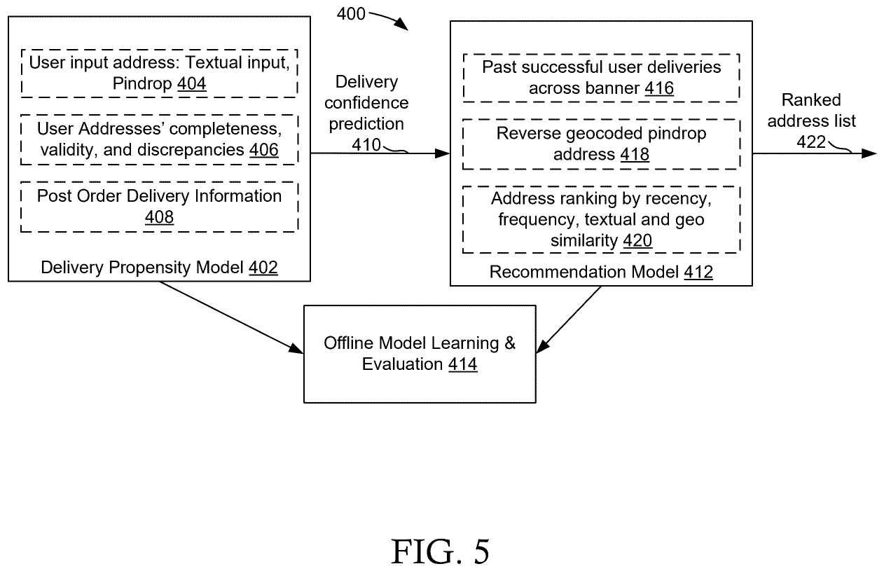

FIG. 5 shows example models used to generate a ranked list of recommended addresses, in accordance with some embodiments. A model architecture 400 includes a delivery propensity model 402, a recommendation model 412, and an offline model learning and evaluation system 414. The delivery propensity model 402, when executed or deployed, generates, as an output, a delivery confidence prediction 410 (e.g., a probability for a successful delivery associated with a respective user input address 404, and/or a quality score for the respective address input 404) to both the recommendation model 412 and the offline model learning and evaluation system 414. The recommendation model 412 also generates, as an output of the model architecture 400, a ranked address list 422, that is also used for further offline model learning and evaluation. The delivery propensity model 402 predicts delivery failures based on an input address and is used to identify problematic address that may cause delivery failures. The delivery propensity model 402 includes a machine learning (ML) model trained on delivery failure outcomes, which may include order cancellations, delivery delays and/or non-deliveries. The delivery propensity model 402 receives address inputs provided by the user, which may include, for example, textual input of addresses such as interior numbers (e.g., apartment number, unit number, room number, office number, etc.), exterior numbers (e.g., building numbers, compound numbers, complex numbers, etc.), street names, city names, town names, county names, colony names, municipality name, state names, province names, postal codes, and/or country names, etc., and/or a pindrop in which the user moves a virtual pin on a digital map to a specific location on the digital map. The address inputs may be optionally stored in whole or in part by the delivery propensity model 402. The delivery propensity model 402 receives, as an input, an output from a component 406 that provides an evaluation of the user input address with respect to completeness, validity (e.g., whether a specific street, town, city, colony, municipality exists in a particular country), and discrepancies.

Table 1 below shows a list of example parameters that are used by the component 406 to determine completeness, validity and checks for discrepancies in the address input 404. Table 1 shows five different categories, each having various features, some of which are represented using Boolean data types. For the category of “address validity,” the user entered address (e.g., textual address) is converted by geocoding into latitude and longitude coordinates. Various portions of the address (e.g., street name, city, county, state, municipality, etc.) are checked to determine if they are valid (e.g., resulting in valid latitude and longitude coordinates) and if the various portions correspond to actual locations within the country specified in the user input (e.g., Mexico, Canada, etc.).

Reverse geocoding converts latitude/longitude coordinates into a textual/human-readable address. For the category of “user address discrepancies,” reverse geocoding is used, for example, to determine whether there is a mismatch (indicated by a Boolean data type) between a portion of the user entered address (e.g., street, postal code, colony, municipality, city, state, etc.) and the corresponding reverse geocoded portion of the address. A numerical value indicating the distance between the location of the user's pindrop and the location provided by a GPS (sometimes also termed “autoloc”) component (e.g., of the location device 68). In some embodiments, delivery propensity model 402 includes a category “target” having a Boolean data type that indicates whether the user address is associated with a successful delivery. For the category of “location service effectiveness,” a precision of reverse geocoding and a precision of the geocoding are used. For example, the precision for the place type of identification may indicate that the address type is rooftop, a residential address, or a non-residential address.

TABLE 1
Example parameters used in the Delivery Propensity Model.

| Category | Feature | Type | Notes |
|---|---|---|---|
| User Address | Interior no. present | Bool | User entered interior |
| completeness | | | no. |
| | Exterior no. present | Bool | |
| | Street present | Bool | |
| | postcode present | Bool | |
| | Colony present | Bool | |
| | Municipality present | Bool | |
| | City present | Bool | |
| | Country present | Bool | |
| Address Validity | Street valid and in country | Bool | Geocoding output |
| (geocoding matches) | | | checked for validity |
| | Postcode valid and in country | Bool | |
| | Colony valid and in country | Bool | |
| | Municipality valid and in country | Bool | |
| | City valid and in country | Bool | |
| | State valid and in country | Bool | |
| | Postcode valid and in country | Bool | |
| | Autoloc_location_type | Cat | Geocoding precision |
| | (confidence/precision) | | |
| Location service | Autoloc_address_type | Cat | Geocoding place |
| effectiveness | | | type identification |
| | Revgecode_location_type | Cat | Reverse geocoding |
| | (confidence/precision) | | precision |
| | Revgeocode_address_type | Cat | Reverse geocoding |
| | | | place type |
| User Address | Distancekm_autoloc_pindroploc | Num | Distance between |
| discrepancies | | | pindrop (obtained |
| (reverse-geocoding | | | from the user) and |
| matches) | | | autoloc (obtained |
| | | | from GPS) |
| | Finalloc_revgeo_street_mismatch | Bool | Mismatch between |
| | | | user entered street |
| | | | and reverse |
| | | | geocoded street |
| | Finalloc_revgeo_postcode_mismatch | Bool | |
| | Finalloc_revgeo_colony_mismatch | Bool | |
| | Finalloc_revgeo_municip_mismatch | Bool | |
| | Finalloc_revgeo_city_mismatch | Bool | |
| | Finalloc_revgeo_state_mismatch | Bool | |
| Target | Last mile delivery failure/success | Bool | |

The delivery propensity model 402 also receives, as an input, an output from a component 408 that evaluates, processes, and/or incorporates post order delivery information. In some embodiments, the post order delivery information may be provided by the user (e.g., specifying a particular location and/or shortcut to deliver an order), by a delivery partner (e.g., based on a prior delivery, or similar deliveries in the vicinity of a location derived from the address input), or by a different source. The delivery confidence prediction 410 is an output (e.g., a probability for a successful delivery associated with a respective user input address 404, and/or a quality score for the respective address input 404) generated by the delivery propensity model 402 based on the user input 404, the component 406, and/or the component 408. For example, the delivery confidence prediction 410 may be the address quality score calculated in the manner described in the following paragraph. In some embodiments, for a delivery confidence prediction 410 that is sufficiently high, the recommendation model 412 forgoes providing a ranked address list of recommended addresses. In some embodiments, for a delivery confidence prediction 410 that is not sufficiently high, the recommendation model 412 provides a ranked address list 422 of recommended addresses. The recommendation model 412 includes a component 416 that stores and/or processes a database of past successful user deliveries across one or more services offered by the ecommerce platform; a component 418 that generates a reverse geocoded pindrop address; and a component 420 that ranks addresses by recency, frequency of usage, textual and geographical similarities. The recommendation model 412 surfaces deliverable address choices, optionally in accordance with a determination that the address inputs 404 provided by the user do not meet a delivery confidence prediction threshold. The recommendation model 412 leverages geocoded, reverse-geocoded and/or past addresses of the user that resulted in successful deliveries.

In some embodiments, an address quality score (e.g., a value between 0-1) is generated for every user entered address to capture the probability (e.g., or efficiency) of the user entered address being an address to which a successful delivery can be made. In some embodiments, the address quality score is an average of various Boolean signals and may include one or more address quality components such as the completeness of the address elements, geocoding matching of various elements, geocoding precision, reverse geocoding matching of elements, reverse geocoding precision, and GPS adjustments. An example collection of Boolean signals includes, some or all of the features having Boolean data types in Table 1. The numerical value of the difference in distance between the pindrop location and the autoloc location is checked against a distance threshold and converted into Boolean data type format. The features having category data types can also be similarly converted into Boolean data type (e.g., geocode_precision==ROOFTOP, revgecode_precision==ROOFTOP, geocode_addr_type in (street_address, premise, subpremise, establishment), revgeocode_addr_type in (street_address, premise, subpremise, establishment), etc.) High address quality score indicates one or more of: completeness of text entries, GPS efficiency and precision, consistency with user's textual address. Address quality has a significant negative correlation with delivery failures, as indicated in Table 2 below.

TABLE 2
Distribution of delivery failure as a function
of different address quality percentile bins.

| Address quality percentile | | |
|---|---|---|
| bins | Delivery failure | Number of orders |
| (0.239, 0.68] | 35.11% | 5771 |
| (0.68, 0.72] | 34.35% | 3013 |
| (0.72, 0.76] | 31.99% | 3804 |
| (0.76, 0.8] | 31.69% | 4986 |
| (0.8, 0.84] | 27.94% | 4975 |
| (0.84, 0.88] | 27.93% | 5832 |
| (0.88, 0.92] | 24.95% | 5596 |
| (0.92, 0.96] | 24.23% | 5605 |
| (0.96, 1.0] | 23.68% | 2327 |

An example of address quality is provided in Table 3 below.

TABLE 3
An example of an address quality

| User- | A user provided address may have one or more of the | | | | | | |
|---|---|---|---|---|---|---|---|
| provided | following components: | | | | | | |
| address | Number | Street | Colony | City | State | Postal | Country |
| | | | | | | Code | |
| Geocoding | A system derived address used to generate latitudinal and | | | | | | |
| address | longitudinal information may have one or more of the | | | | | | |
| | following components: | | | | | | |
| | — | — | Colony | City | Derived | Derived | Country |
| | | | | | State | Postal | |
| | | | | | | Code | |
| Reverse | A system derived textual address based on latitudinal and | | | | | | |
| Geocoding | longitudinal information obtained from the location device | | | | | | |
| address | 68 (autolocation) or from a user pindrop may have one or | | | | | | |
| | more of the following components: | | | | | | |
| | Derived | Street | Colony | City | State | Derived | Country |
| | number | | | | | Postal | |
| | | | | | | Code | |

| | |
|---|---|
| Auto- | Latitudinal and longitudinal coordinates determined by the |
| location | user device |
| Pindrop | User-provided latitudinal and longitudinal coordinates |
| Distance | Numerical difference between the latitudinal and longitudinal |
| (autoloc, | coordinates determined by the user device, and user-provided |
| pindrop) | latitudinal and longitudinal coordinates |
| Address | 0.56 |
| quality | |

In the example shown in Table 3, the address quality was determined to be 0.56 (e.g., a relatively low quality address) due to the user-entered street being incorrect (e.g., street is not found in geocoding, there is a mismatch in reverse geocoding, and the distance discrepancy is significant (e.g., close to 1 km)). For example, the autolocation coordinates include a pair numerical values corresponding to a longitude (e.g., a numerical value within a range spanning from −180° to) 180°, and a latitude (e.g., a numerical value within a range spanning from −90° to) 90° and respectively (e.g., in a pair of numerical values formatted as (longitude, latitude)). Alternatively, the autolocation coordinates may be in a pair of numerical values formatted as (latitude, longitude)). Similarly, the user pindrop may also be converted from a position on a graphical map into a pair numerical coordinates or values corresponding to a latitude (e.g., a numerical value within a range spanning from −90° to) 90° and a longitude (e.g., a numerical value within a range spanning from −180° to 180°), respectively. Alternatively, the pindrop coordinates may be in a pair of numerical values formatted as (latitude, longitude)). In Table 3, the component “Derived State” in the geocoding address indicates that the system derived state is different from the user-provided state. In contrast, the component “Colony” in the geocoding address indicates that the system derived colony matches the user-provided colony.

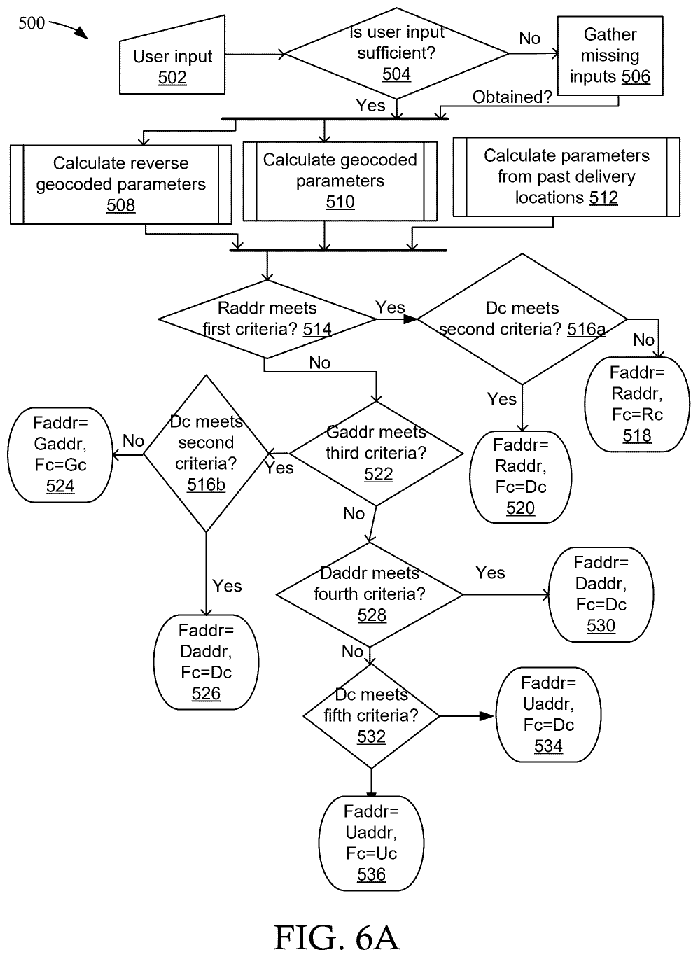

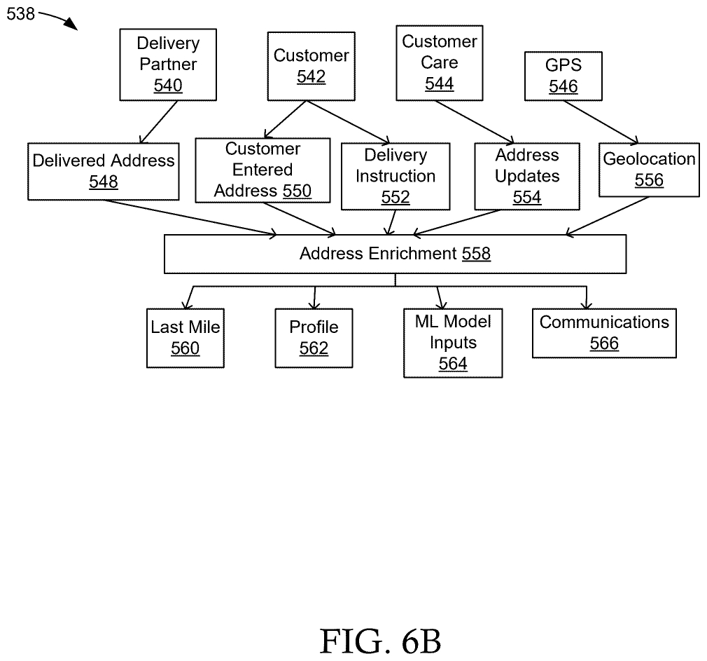

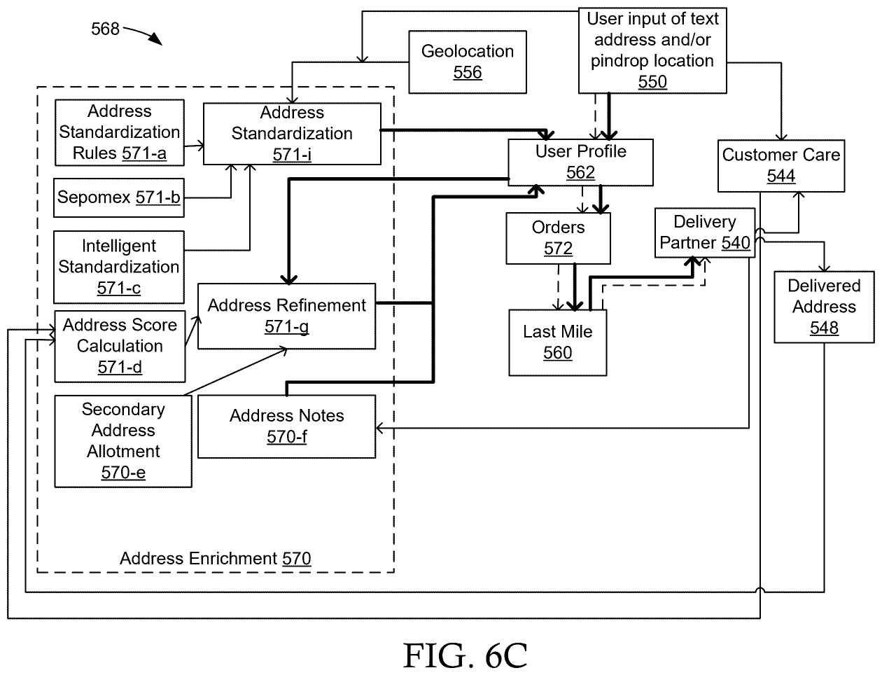

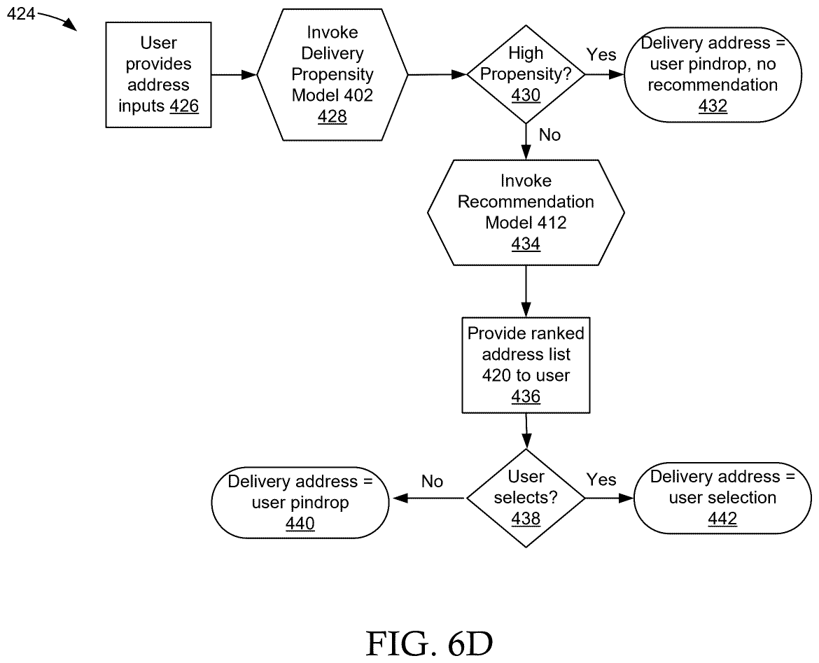

FIG. 6A shows an example algorithm for enriching an address input provided by a user, in accordance with some embodiments. An enrichment approach to recommending an address to a user based on the address provided may be better able to align with user intent than offering an alternate address to the user. The example algorithm 500 starts with receiving user input (e.g., textual input such a textual address Uaddr, and/or a pindrop via which the user provides latitude and longitudinal coordinates Uc) at step 502. At step 504, the algorithm 500 determines whether the user input received from step 502 is sufficient (e.g., via component 406, which uses one or more parameters from the list of example parameters shown in Table 1). In accordance with a determination that the user input is not sufficient, the algorithm 500 proceeds to gather missing inputs at step 506. In accordance with a determination that the user input is sufficient, the algorithm 500 proceeds to calculate various parameters: reverse geocoded parameters are calculated at step 508 (e.g., as explained with reference to the example parameters in Table 1); geocoded parameters are calculated at step 510 (e.g., as explained in the paragraph below); and parameters from past delivery locations are calculated at step 512 (e.g., as explained in the paragraph below).

Examples of geocoded parameters include geocoded latitude and longitudinal coordinates Gc geocoded based on the textual address Uaddr provided by the user, and/or a high (e.g., highest) precision geocoded text address Gaddr, obtained based on Uaddr. Examples of reverse geocoded parameters include a high (e.g., highest) precision reverse-geocoded text address Raddr by reverse geocoding Uc, and/or reverse geocoded latitude and longitudinal coordinates Rc (e.g., may be the same or very close to Uc determined from the user pindrop). Examples of parameters from past delivery locations include a high (e.g., highest) precision reverse-geocoded textual address Daddr obtained from a median point Dc of the locations (e.g., indicated by latitude and longitude coordinates) of past deliveries (e.g., a minimum of 3 locations), and a mean deviation MeanDev(D) that is a mean of a distance (e.g., a Haversine distance) between the average latitude and longitude coordinates of delivered datapoints (e.g., locations of past deliveries) and a respective delivery location.

The calculated parameters from steps 508, 510, and 512 are used to make various determinations. At step 514, the algorithm 500 determines if the reverse-geocoded address Raddr meets first criteria. In some embodiments, the first criteria include matching of key elements (e.g., exterior number of a building, street, city, postal code, etc.) between Raddr and the user provided textual address Uaddr, and/or whether Raddr has high precision. In accordance with a determination that the first criteria are met, the algorithm 500 determines, at step 516a if various parameters from past delivery locations meet second criteria. In some embodiments, the second criteria include determining if the median point De is available, if MeanDev(D) is below a threshold (e.g., 500 m, 300 m, 200 m, 100 m, or another numerical value) and/or if a distance (e.g., a Haversine distance) difference between Dc and Rc is below a threshold (e.g., 500 m, 300 m, 200 m, 100 m, or another numerical value). In accordance with a determination that the various parameters from past delivery locations meet second criteria, at step 520 the reverse-geocoded address Raddr is provided to the user as the final recommended textual address Faddr, and the median point Dc is provided to the user as the final recommended latitude and longitude coordinates. In accordance with a determination that the various parameters from past delivery locations do not meet second criteria, at step 518, the reverse-geocoded address Raddr is provided to the user as the final recommended textual address Faddr, and the reverse geocoded latitude and longitudinal coordinates Rc is provided to the user as the final recommended latitude and longitude coordinates.

Returning to step 514, and in accordance with a determination that the first criteria are not met, the algorithm 500 determines, at step 522 if various geocoded parameters meet third criteria. In some embodiments, the third criteria include matching of key elements (e.g., an exterior building number, street, city, postal code, etc.) between the geocoded address Gaddr and the user provided textual address Uaddr, and/or whether Gaddr has high precision. In accordance with a determination that the third criteria are met, the algorithm 500 determines, at step 516b if various parameters from past delivery locations meet second criteria. In some embodiments, the second criteria include determining if the median point De is available, if MeanDev(D) is below a threshold (e.g., 500 m, 300 m, 200 m, 100 m, or another numerical value) and/or if a distance (e.g., a Haversine distance) difference between Dc and Ge is below a threshold (e.g., 500 m, 300 m, 200 m, 100 m, or another numerical value). In accordance with a determination that the various parameters from past delivery locations meet second criteria, at step 524, the geocoded address Gaddr is provided to the user as the final recommended textual address Faddr, and the median point De is provided to the user as the final recommended latitude and longitude coordinates. In accordance with a determination that the various parameters from past delivery locations do not meet second criteria, at step 524, the geocoded address Gaddr is provided to the user as the final recommended textual address Faddr, and the geocoded latitude and longitudinal coordinates Gc is provided to the user as the final recommended latitude and longitude coordinates.

Returning to step 522, in accordance with a determination that the third criteria are not met, the algorithm 500 determines, at step 528 if various parameters from past delivery locations meet fourth criteria. In some embodiments, the fourth criteria include matching of key elements (e.g., exterior number on a building, street, city, postal code, etc.) between the high (e.g., highest) precision reverse-geocoded textual address Daddr and the user provided textual address Uaddr, and/or whether Daddr has high precision. In accordance with a determination that the fourth criteria are met, at step 530, the reversed geocoded address Daddr obtained from reverse-geocoding Dc is provided to the user as the final recommended textual address Faddr, and the median point Dc is provided to the user as the final recommended latitude and longitude coordinate. In accordance with a determination that the fourth criteria are not met, the algorithm 500 determines, at step 532 if various parameters from past delivery locations meet fifth criteria. The fifth criteria include determining if the median point De is available, if MeanDev(D) is below a threshold (e.g., 500 m, 300 m, 200 m, 100 m, or another numerical value) and/or if a distance (e.g., a Haversine distance) difference between Dc and Uc is below a threshold (e.g., 500 m, 300 m, 200 m, 100 m, or another numerical value). In accordance with a determination that the various parameters from past delivery locations meet fifth criteria, at step 534, the user provided textual address Uaddr is provided to the user as the final recommended textual address Faddr, and the median point Dc is provided to the user as the final recommended latitude and longitude coordinates. In accordance with a determination that the various parameters from past delivery locations do not meet the fifth criteria, at step 536, the user provided textual address Uaddr is provided to the user as the final recommended textual address Faddr, and the user provided coordinates Uc is provided to the user as the final recommended latitude and longitude coordinates.

Tables 4-5 below illustrate three examples of address enrichment, in accordance with some embodiments.

TABLE 4
A first example of address enrichment in accordance with some embodiments.

| | Original | Enriched |
|---|---|---|
| Interior_num | — | — |
| Exterior_num | User-provided number | User-provided number |
| Street | User-provided street | User-provided street |
| Colony | — | Enriched colony |
| City | User-provided city | User-provided city |
| State | User-provided state | Enriched/ corrected state |
| Post_code | User-provided postal code | Enriched/ corrected postal |
| | | code |
| Country | User-provided country | User-provided country |
| Coordinates | User-provided latitudinal and | Enriched/ corrected latitudinal |
| | longitudinal coordinates | and longitudinal coordinates |

| | |
|---|---|
| Delivery coordinates | latitudinal and longitudinal coordinates from a past delivery) |

TABLE 5
A second example of address enrichment in accordance with some embodiments.

| | Original | Enriched |
|---|---|---|
| Interior_num | — | — |
| Exterior_num | User-provided number | User-provided number |
| Street | User-provided street | Corrected/enriched street |
| Colony | — | Enriched colony |
| City | User-provided city | User-provided city |
| State | User-provided state | Enriched/ corrected state |
| Post_code | User-provided postal code | User-provided postal code |
| Country | User-provided country | User-provided country |
| Coordinates | User-provided latitudinal and | Enriched/ corrected latitudinal |
| | longitudinal coordinates | and longitudinal coordinates |

| | |
|---|---|
| Delivery coordinates | — |

TABLE 6
A third example of address enrichment
in accordance with some embodiments.

| | Original | Enriched |
|---|---|---|
| Interior_{—} | — | — |
| num | | |
| Exterior_{—} | User-provided number | User-provided number |
| num | | |
| Street | User-provided street | Corrected/enriched street |
| Colony | User-provided colonyt | Corrected/enriched colony |
| City | User-provided city | Corrected/enriched city |
| State | User-provided state | Corrected/enriched state |
| Post_code | User-provided postal code | User-provided postal code |
| Country | User-provided country | User-provided country |
| Coordinates | — | Enriched/ corrected latitudinal |
| | | and longitudinal coordinates |

In the first example of address enrichment shown in Table 4, the original address entered by the user has distorted latitude and longitude coordinates (e.g., from errors in the pindrop location), does not include information in the colony field, and the final recommended address is enriched by geocoding. In the second example of address enrichment shown in Table 5, the original address entered by the user does not include information in the colony field, and the final recommended address is enriched by reverse-geocoding. In the third example of address enrichment shown in Table 6, the user input lacks the pindrop coordinates (e.g., the user did not provide a pindrop location), and the final recommended address is enriched by geocoding. The city name provided by the user is also corrected using geocoding.

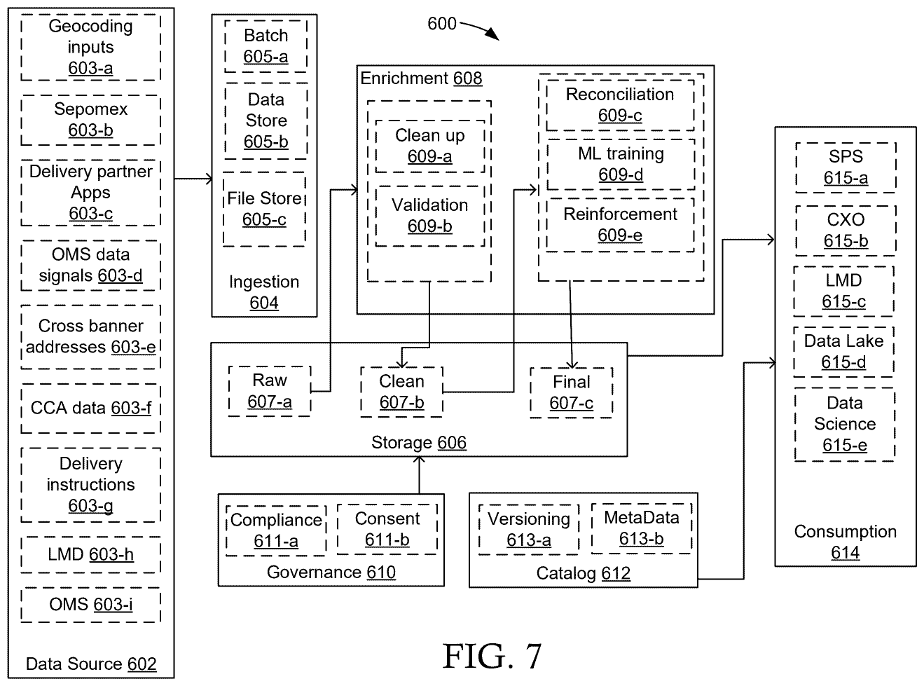

FIG. 6B shows an example system that incorporates a component for enriching an address input provided by a user, in accordance with some embodiments. The example system 538 shows four sources of information through which information is provided to the system 538. Information about an address to which an item on an ecommerce platform is delivered (e.g., a delivered address 548) is provided by a delivery partner 540 to an address enrichment component 558. Similarly, a customer 542 may provide a user entered address 550 in the course of placing an order for an item on the ecommerce platform. In addition to the user entered address 550, the customer 542 may also provide additional delivery instructions 552 (e.g., to deliver the item at a lobby area, to deliver the item at a different location from the entered address) to the address enrichment component 558. In some embodiments, a customer service representative and/or customer care provider 544 may provide address updates 554 to the address enrichment component 558. For example, the customer 542 may call the customer care provider 544 to update an address after the order has been placed using an older address, or the delivery partner 540 may inform the customer care provider 544 that the actual delivered address 548 differs from the user entered address 550. A GPS component 546 may also provide geolocation information (e.g., latitude and longitude coordinates) to the address enrichment component 558. For example, the customer 542 may be making the order via a mobile device having a GPS component 546 that can provide the geolocation of the customer 542 when the order was made. The address enrichment component 558 may implement the example address enrichment algorithm 500 described in FIG. 7A to provide a final recommended address (Faddr and/or Fc) as an output. The output may be provided to and/or saved into a user profile 562 of the customer 542, the output may also be used as an input 564 to a machine learning model, the output may be provided to a delivery partner 540 making the last mile delivery 560, and/or the output may be used for communications 566 between customer 542 and one or more of a delivery partner 540, the customer care provider 544, and/or the ecommerce platform.

FIG. 6C shows another example system that incorporates a component for enriching an address input provided by a user, in accordance with some embodiments. The example system 568 includes an address enrichment component 570 having various units. The address enrichment component 570 receives, via an address standardization unit 571-i that parses one or more of: address standardization rules 571-a, third party databases 571-b (e.g., from Sepomex), and/or other intelligent standardization unit 571-c, user entered address 550, and geolocation information 556 (e.g., latitude and longitude coordinates obtained from a GPS component). The bolded arrows indicate how an enriched address is transmitted and/or updated within the system 568. The dashed arrows indicate how the user entered address is transmitted within the system 568. The delivered address 548 and additional information received by the customer care provider 544 are provided to an address score calculation unit 571-d (e.g., the delivery propensity model 402, or another score calculation unit) within the address enrichment component 570. In some embodiments, the delivered address 548 provides feedback indicating an outcome of a delivery associated with the enriched address. Sending the feedback back to the address enrichment component 570 allows one or more machine learning models to be retained based on the feedback (e.g., to provide more accurate address score calculation, and/or to recommend better enriched addresses). The output of the address enrichment component 570 may be sent to the user profile 562 so that the enriched address may be associated with one or more orders 572 of the user, and be provided to the delivery partner 540 who is making the last mile delivery 560. The delivery partner 540 may also provide address notes 570-f (e.g., details from the delivery, preferred delivery coordinates (e.g., gate), and/or details for locations without structured addresses) to the address enrichment component 570. Information from the user profile 562 may be provided to the address refinement unit 571-g to generate one or more enriched addresses. The address refinement unit 571-g also receives input from the address score calculation unit 571-d, and/or a secondary address allotment unit 570-c.

FIG. 6D shows an example method for selecting a delivery address, in accordance with some embodiments. The example method 424 begins by receiving address inputs 426 for the delivery address, sometimes also referred to as address inputs 426. The method 424 invokes the delivery propensity model 402 (as described in FIG. 5) and provides address inputs 426 to the delivery propensity model 402, which provides as an output, a probability for a successful delivery associated with respective address inputs 426 from the user (and/or a quality score for respective address input 426). The method 424 also sets a threshold to differentiate between addresses that have a high propensity for items to be successfully delivered to and addresses that do not have a high propensity for items to be successfully delivered to. The method 424 determines at step 430 whether the output from the delivery propensity model 402 (e.g., the probability for a successful delivery, and/or a quality score for an address input) is greater than the threshold. If so, the delivery address is set to the address inputs 426 (e.g., a user pindrop, and/or textual address input), and no address recommendation is provided at step 432. If the output from the delivery propensity model 402 is less than the threshold, the method 424 invokes the recommendation model 412 (described in FIG. 5) at step 434 to provide, as an output of the recommendation model 412, a ranked address list 422 of address recommendations to the user at step 436 of the method 424.

The method 424 makes a determination at step 438 (e.g., by detecting the presence or absence of a user input directed at one of the entries provided in the ranked address list 422) whether the user selects one of the entries provided in the ranked address list 422. If the user selects an address from the ranked address list 422, the address selected by the user from the ranked address list 422 is selected as the delivery address at step 442 (e.g., the address selected by the user is provided to a delivery partner 540). If the user does not select any address from the ranked address list 422, the delivery address is set to the address inputs 426 (e.g., a user pindrop, and/or textual address input) at step 440 (e.g., address inputs 426 are provided to a delivery partner 540).

Thus, for some (e.g., all) of the address inputs 426 which are below the threshold (or above a failure probability threshold), an address recommendation (e.g., provided in a ranked address list 422) having a higher probability of achieving successful delivery is generated. The address recommendation model 412 utilizes geocoding functionality and delivery history to arrive at one or more enriched and recommended address. In some embodiments, one or more alternate addresses are provided to the user if the address input 426 provided by the user has a low probability of achieving a successful delivery. The methods and systems described herein can be easily integrated with downstream systems (e.g., systems providing checkout functionalities, or apps by one or more delivery partners) that need an accurate delivery address for an order a user makes using the ecommerce platform. In some embodiments, the systems and methods analyze, based on delivery outcome feedback information from one or more downstream systems, how to make recommendations more efficiently and modify the output of the system in a subsequent run. The methods and systems are also able to resolve inconsistency or quality issues when the ecommerce platform adds new services onto the platform. The address recommendation may also be leveraged by the ecommerce platform to persists in respective user profiles of one or more user accounts and/or with one or more delivery partners as one or more alternate recommended addresses that can be used for navigation to deliver an item ordered on the ecommerce platform.

FIG. 7 illustrates an example domain architecture for providing enriched addresses, in accordance with some embodiments. The example architecture 600 includes a data source 602. The data source 602 may include one or more of: geocoding inputs 603-a, input from third party databases, such as a database from Sepomex 603-b, input from apps of delivery partners 603-c; data from other services 603-e maintained by the ecommerce platform, data from costumer care application 603-f (CCA), delivery instructions 603-g provided by the user, data from last mile delivery 603-h (LMD), data from Order Management System 603-i (OMS), such as data provided by a user when placing an order, and data signals 603-d from OMS (e.g., indicating an outcome of a delivery, and/or changes made during deliveries). The data from the data source 602 is provided to an ingestion module 604, which may be an offline unit. The ingestion module 604 may perform one or more of: batching the received data from the data source 602 (via a batching module 605-a), storing that data, comparing the received data against a data store 605-b or a file store 605-c. The file store 6050-c may include data from third party databases that list, for example, colonies and other streets/postal code. The ingested data is provided to a storage module 606, which is then sent to an enrichment module 608. The storage module 606 may be a data warehouse that is centralized and/or allows offline access. The enrichment module 608 may clean up and/or validate the raw data 607-a received from the storage module 606 (e.g., by normalizing the raw data and/or performing relevant clean up or validation of the raw data), before sending the cleaned data 607-b (e.g., a refined layer of data, cleaned up and/or validated data) back to the storage module 606. The cleaned data 607-b is then provided to one or more of a machine learning component 609-d, a data reconciliation component 609-c, and/or an reinforcement learning component 609-c of the enrichment module 608. The enrichment module 608 includes the delivery propensity model 402 described above in FIG. 5. In some embodiments, the delivery propensity model 402 is an XGBoost model trained or learned on a large sample of orders (e.g., last mile orders, a sample of tens of thousands of samples) that include delivery failures (e.g., delays, misses, delivery cancellations). For example, 42 thousand last mile orders with 29% delivery failures in Mexico may be used to train the XGBoost model. An area under the precision-recall curve (AUPRC) for the such an example may be about 0.35, and an area under the receiver operating characteristic (AUROC) may be about 0.57. AUROC reflects the model's ability to differentiate between positive cases (e.g., a problematic address), and negative cases (e.g., a non-problematic address). A benchmark test for the accuracy of the model in detecting problematic addresses is conducted using a 80%-20% train-test split (e.g., 80% of the data is used to train, and the remaining 20% of the data is used test the trained model) with a threshold of 35% delivery failure propensity shows the model has an accuracy of 68%. Table 7 below summarizes an example of an accuracy of the model to classify the test data into two classes-addresses that would result in a successful delivery and addresses that would result in a delivery failure.

TABLE 7
Classification results of the model,
in accordance with some embodiments

| Class | Precision | Recall | F1-score | Support |
|---|---|---|---|---|
| Delivery_success | 0.72 | 0.88 | 0.79 | 5938 |
| Delivery_failure | 0.39 | 0.19 | 0.26 | 2444 |

The results show that delivery failures may also be due to other factors like supply chain issues, order content issues. In some embodiments, the importance (e.g., in ascending order) of features relevant to identifying delivery failure may be: precision of geocoding; whether there is a mismatch between the reverse geo-coded postal code and the user entered postal code; whether the entered city is valid; whether the street name entered by the user is valid, whether there is a mismatch between the reverse geo-coded city and the user entered city; mismatch between the reverse geo-coded colony and the user entered colony; whether the reverse geo-coded country name is the user entered country (e.g., in Mexico); whether the entered colony is valid; whether the interior number is present; whether the municipality is present; the precision of reverse geocoding; whether there is a mismatch between the reverse geocoded street; the quality (e.g., based on the quality score) of the address; whether there is a mismatch between the reverse geocoded state; the address type based on geocoding (e.g., residential, non-residential); the address type based on reverse-geocoding; and the distance between the autolocation (from GPS signals or IP address information) and the user pindrop location.

The architecture 600 also includes a governance module 610 that receives or stores information about compliance requirements 611-a (e.g., country specific compliance requirements), and/or stores consent information 611-b (e.g., data and/or signals indicating consent, and/or specifying how information may be processed and/or stored). Information from the governance module 610 is provided to the storage module 606. A catalog module 612 in the architecture 600 keeps track of the version 613-a of the enriched address output, and metadata 613-b might be used to allow only portions of the address to be provided to a consumption module 614 (e.g., the entire address need not be visible for downstream purposes).

The enriched output (e.g., an enriched address) from the enrichment module 608 is sent downstream to the consumption module 614, which directs the enriched address to a single profile service 615-a (SPS), CXO 615-b, one or more parties involved in last mile delivery 615-c (LMD), and/or data warehousing ecosystems such as Data Lake 615-d and Data Science 615-c.

The methods and systems described herein are able to check, against a government database (e.g., Sepomex), hundreds of thousands of addresses (e.g., in one example, about 0.60 million) which may have inconsistent data and/or missing latitude and longitude coordinates, and presenting the enriched addresses (e.g., having corrected data and filled in latitude and longitude coordinates) to a user during a checkout process on the ecommerce platform. In some embodiments, addresses of low quality which may have higher delivery failure propensity are identified across multiple services on the ecommerce platform and offering enriched addresses to the users for adoption. In some embodiments, address quality scoring and/or delivery propensity model scoring can be used to identify and prioritize user addresses for enrichment. In some embodiments, the model scores and enriched addresses can be data attributes that can be leverage by additional components within the ecommerce platform. In some embodiments, the enriched addresses are coupled with user profile (e.g., user profile 562). In some embodiments, the enriched addresses are not coupled with a specific user profile and a user may proactively disable the provision of enriched addresses, and/or limit the enriched addressed for specific application (e.g., only for last mile delivery).

It will be appreciated that identification of problematic addresses, and the generation of enriched addresses as disclosed herein, particularly on large datasets intended to be used within large networks such as ecommerce networks, is only possible with the aid of computer-assisted machine-learning algorithms and techniques, such as the disclosed delivery propensity models. In some embodiments, machine learning processes including trained delivery propensity models are used to perform operations that cannot practically be performed by a human, either mentally or with assistance, such as identification of problematic addresses, and the generation of enriched addresses. It will be appreciated that a variety of machine learning techniques can be used alone or in combination to generate trained delivery propensity models for identifying problematic addresses so that enriched addresses may be provided to a user within a network environment.

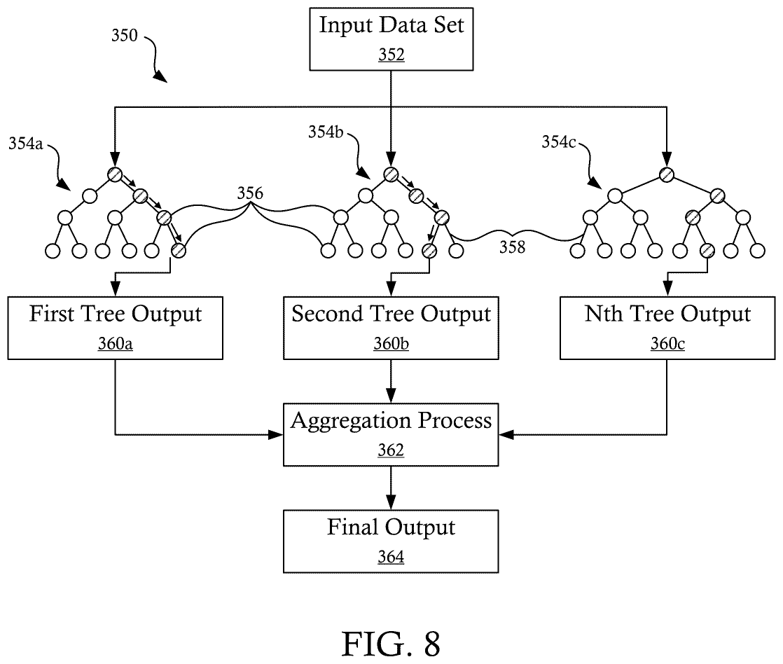

FIG. 8 illustrates a tree-based ensemble machine learning model 350, in accordance with some embodiments. In particular, the tree-based ensemble machine learning model 350 is a random forest neural network, though it will be appreciated that the discussion herein is applicable to other decision tree neural networks. The tree-based ensemble machine learning model 350 includes a plurality of trained decision trees 354a-354c each including a set of nodes 356 (also referred to as “leaves”) and a set of edges 358 (also referred to as “branches”).

Each of the trained decision trees 354a-354c may include a classification and/or a regression tree (CART). Classification trees include a tree model in which a target variable may take a discrete set of values, e.g., may be classified as one of a set of values. In classification trees, each leaf 356 represents class labels and each of the branches 358 represents conjunctions of features that connect the class labels. Regression trees include a tree model in which the target variable may take continuous values (e.g., a real number value).

In operation, an input data set 352 including one or more features or attributes is received. A subset of the input data set 352 is provided to each of the trained decision trees 354a-354c. The subset may include a portion of and/or all of the features or attributes included in the input data set 352. Each of the trained decision trees 354a-354c is trained to receive the subset of the input data set 352 and generate a tree output value 360a-360c, such as a classification or regression output. The individual tree output value 360a-360c is determined by traversing the trained decision trees 354a-354c to arrive at a final leaf (or node) 356.

In some embodiments, the tree-based ensemble machine learning model 350 applies an aggregation process 362 to combine the output of each of the trained decision trees 354a-354c into a final output 364. For example, in embodiments including classification trees, the tree-based ensemble machine learning model 350 may apply a majority-voting process to identify a classification selected by the majority of the trained decision trees 354a-354c. As another example, in embodiments including regression trees, the tree-based ensemble machine learning model 350 may apply an average, mean, and/or other mathematical process to generate a composite output of the trained decision trees. The final output 164 is provided as an output of the tree-based ensemble machine learning model 350.

The address enrichment methods and systems described herein may be used across multiple markets, are not dependent on any third-party databases and can be leveraged by and integrated into different geographical locations. External databases such as those provided by the USPS or the Canadian Postal Service, if available, can provide an additional data signal. In some embodiments, the methods and systems described herein flag potentially problematic addresses entered by the user, and/or correct problematic addresses through enrichment and reduce the impact of problematic addresses on delivery.

In some embodiments, an address improvement computing device 4 can include and/or implement one or more trained models, such as one or more delivery propensity models. In some embodiments, one or more trained models can be generated using an iterative training process based on a training dataset. FIG. 9 illustrates a method 200 for generating a trained model, such as a trained optimization model, in accordance with some embodiments. FIG. 10 is a process flow 250 illustrating various steps of the method 200 of generating a trained model, in accordance with some embodiments. At step 202, a training dataset 252 is received by a system, such as a processing device 10. The training dataset 252 can include labeled and/or unlabeled data. For example, in some embodiments, a set of labeled delivery addresses is provided for use in training a model.

At optional step 204, the received training dataset 252 is processed and/or normalized by a normalization module 260. For example, in some embodiments, the training dataset 252 can be augmented by imputing or estimating missing values of one or more features associated with a trained delivery propensity model. In some embodiments, processing of the received training dataset 252 includes outlier detection to remove data likely to skew training of a delivery propensity model. In some embodiments, processing of the received training dataset 252 includes removing features that have limited value with respect to training of the delivery propensity model.

At step 206, an iterative training process is executed to train a selected model framework 262. The selected model framework 262 can include an untrained (e.g., base) machine learning model, such as a multiclass classification framework (e.g., XGBoost), and/or a partially or previously trained model (e.g., a prior version of a trained model). The training process iteratively adjusts parameters (e.g., hyperparameters) of the selected model framework 262 to minimize a cost value (e.g., an output of a cost function) for the selected model framework 262.

The training process is an iterative process that generates set of revised model parameters 266 during each iteration. The set of revised model parameters 266 can be generated by applying an optimization process 264 to the cost function of the selected model framework 262. The optimization process 264 can reduce the cost value (e.g., reduce the output of the cost function) at each step by adjusting one or more parameters during each iteration of the training process.

After each iteration of the training process, at step 208, a determination is made whether the training process is complete. The determination at step 208 can be based on any suitable parameters. For example, in some embodiments, a training process can complete after a predetermined number of iterations. As another example, in some embodiments, a training process can complete when it is determined that the cost function of the selected model framework 262 has reached a minimum, such as a local minimum and/or a global minimum.

At step 210, a trained delivery propensity model 268 is output and provided for use in improving a user provided address, such as the address enrichment method 100 discussed above with respect to FIGS. 3-4. At optional step 212, a trained delivery propensity model 268 can be evaluated by an evaluation process 270. A trained model can be evaluated based on any suitable metrics, such as, for example, an F or FI score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the subject matter has been described in terms of example embodiments, it is not limited thereto. Rather, the appended claims should be construed broadly, to include other variants and embodiments, which may be made by those skilled in the art.

What is claimed is:

1. A system, comprising:
a processor; and
a non-transitory memory storing instructions, that when executed, cause the processor to:
receive a set of address element inputs via a first interface;
compute a quality metric based on the set of address element inputs using a first machine learning model;
in accordance with a determination that the quality metric does not meet a threshold, generate an enriched address based on the set of address element inputs;
receive feedback indicating an outcome of a delivery associated with the enriched address; and
re-train the first machine learning model based on the feedback.

2. The system of claim 1, wherein the set of address element inputs received via the first interface comprises a textual address and the instructions that cause the processor to generate the enriched address further comprise instructions to:
automatically convert the textual address into a location on a map; and
display, on the map, a graphical user interface element indicative of the location.

3. The system of claim 1, wherein the instructions that cause the processor to generate the enriched address further comprise instructions to:
automatically determine latitudinal and longitudinal coordinates of a user providing the set of address element inputs; and
display an interactive graphical user interface element that allows the user to obtain a user adjusted location for the enriched address based on movement of the interactive graphical user interface element.

4. The system of claim 3, wherein the quality metric comprises an address quality score computed at least in part based on a numerical value of a difference in distance between the user adjusted location and the determined latitudinal and longitudinal coordinates of the user providing the set of address element inputs.

5. The system of claim 1, wherein the first machine learning model used to compute the quality metric computed based on the set of address element inputs comprises a machine learning model trained on delivery failure outcomes comprising one or more of cancellations, delays or non-delivery.

6. The system of claim 1, wherein the instructions that cause the processor to generate the enriched address further comprise instructions to generate, using a recommendation model, a set of deliverable address choices that are generated based on geocoded, reverse-geocoded or past addresses associated with the set of address element inputs that resulted in successful deliveries.

7. The system of claim 1, wherein the first machine learning model is trained using a data source that comprises one or more of: geocoding inputs, input from third party databases, user provided delivery instructions, data from last mile deliveries, data signals indicating an outcome of a delivery, or changes made during deliveries.

8. A computer-implemented method, comprising:
receiving a set of address element inputs via a first interface;
computing a quality metric based on the set of address element inputs using a first machine learning model;
in accordance with a determination that the quality metric does not meet a threshold, generating an enriched address based on the set of address element inputs;
receiving feedback indicating an outcome of a delivery associated with the enriched address; and
re-training the first machine learning model based on the feedback.

9. The computer-implemented method of claim 8, wherein the set of address element inputs received via the first interface comprises a textual address and generating the enriched address further comprises:
automatically converting the textual address into a location on a map; and
displaying, on the map, a graphical user interface element indicative of the location.

10. The computer-implemented method of claim 8, wherein generating the enriched address further comprises:
automatically determining latitudinal and longitudinal coordinates of a user providing the set of address element inputs; and
displaying an interactive graphical user interface element that allows the user to obtain a user adjusted location for the enriched address based on movement of the interactive graphical user interface element.

11. The computer-implemented method of claim 10, wherein the quality metric comprises an address quality score computed at least in part based on a numerical value of a difference in distance between the user adjusted location and the determined latitudinal and longitudinal coordinates of the user providing the set of address element inputs.

12. The computer-implemented method of claim 8, wherein the first machine learning model used to compute the quality metric computed based on the set of address element inputs comprises a machine learning model trained on delivery failure outcomes comprising one or more of cancellations, delays or non-delivery.

13. The computer-implemented method of claim 8, wherein generating the enriched address further comprises generating, using a recommendation model, a set of deliverable address choices that are generated based on geocoded, reverse-geocoded or past addresses associated with the set of address element inputs that resulted in successful deliveries.

14. The computer-implemented method of claim 8, wherein the first machine learning model is trained using a data source that comprises one or more of: geocoding inputs, input from third party databases, user provided delivery instructions, data from last mile deliveries, data signals indicating an outcome of a delivery, or changes made during deliveries.

15. A non-transitory computer readable medium having instructions stored thereon, wherein the instructions, when executed by at least one processor, cause at least one device to perform operations comprising:
receiving a set of address element inputs via a first interface;
computing a quality metric based on the set of address element inputs using a first machine learning model;
in accordance with a determination that the quality metric does not meet a threshold, generating an enriched address based on the set of address element inputs;
receiving feedback indicating an outcome of a delivery associated with the enriched address; and
re-training the first machine learning model based on the feedback.

16. The non-transitory computer readable medium of claim 15, wherein the set of address element inputs received via the first interface comprises a textual address and the instructions that cause the at least one device to perform operations further comprise instructions to:
automatically convert the textual address into a location on a map; and
display, on the map, a graphical user interface element indicative of the location.

17. The non-transitory computer readable medium of claim 15, wherein the instructions that cause the at least one device to perform operations further comprise instructions to:
automatically determine latitudinal and longitudinal coordinates of a user providing the set of address element inputs; and
display an interactive graphical user interface element that allows the user to obtain a user adjusted location for the enriched address based on movement of the interactive graphical user interface element.

18. The non-transitory computer readable medium of claim 17, wherein the quality metric comprises an address quality score computed at least in part based on a numerical value of a difference in distance between the user adjusted location and the determined latitudinal and longitudinal coordinates of the user providing the set of address element inputs.

19. The non-transitory computer readable medium of claim 15, wherein the first machine learning model used to compute the quality metric computed based on the set of address element inputs comprises a machine learning model trained on delivery failure outcomes comprising one or more of cancellations, delays or non-delivery.

20. The non-transitory computer readable medium of claim 15, wherein the first machine learning model is trained using a data source that comprises one or more of: geocoding inputs, input from third party databases, user provided delivery instructions, data from last mile deliveries, data signals indicating an outcome of a delivery, or changes made during deliveries.
